(19) United States
(12) Patent Application Publication
(10) Pub. No.: US 2026/0167419 A1
(43) Pub. Date: Jun. 18, 2026

(54) REFUSE STORAGE AND COMPACTION MONITORING

(71) Applicant: The Heil Co., Chattanooga, TN (US)

(72) Inventors: Joseph Henry Mills, Dunwoody, GA (US); David C. Gentry, Chattanooga, TN (US); Anthony Bryan Giles, Signal Mountain, TN (US)

(21) Appl. No.: 19/425,610

(22) Filed: Dec. 18, 2025

Related U.S. Application Data
(60) Provisional application No. 63/735,798, filed on Dec. 18, 2024.

(51) Int. Cl. B65F 3/22; B65F 3/02; B65F 3/04; B65F 3/14

(52) U.S. Cl. CPC B65F 3/22; B65F 3/041; B65F 2003/0269; B65F 2003/146

(57) ABSTRACT

Systems for assessing a volumetric fullness of a storage container of a refuse collection vehicle include a vehicle chassis, a refuse body on the vehicle chassis, a sensor, and a controller. The refuse body includes a hopper, a storage container, a lift, and a packer. The storage container defines an enclosed volume for containing waste. The lift is configured to service a refuse container proximate the refuse collection vehicle by engaging the refuse container, lifting the refuse container, and depositing waste from the refuse container into the hopper. The packer is configured to transfer waste from the hopper into the storage container and to pack waste within the storage container. The sensor is configured to monitor a packer load. The controller is communicatively coupled to the sensor and is configured to assess, based on packer load data generated by the sensor, a volumetric fullness of the storage container.

### CROSS-REFERENCE TO RELATED APPLICATION

This application claims the benefit of the U.S. Provisional Ser. No. 63/735,798, filed Dec. 18, 2024, which is incorporated herein by reference in its entirety.

### TECHNICAL FIELD

This disclosure relates to the field of refuse collection, storage, and compaction.

### BACKGROUND

Refuse collection vehicles are typically used to pick up quantities of refuse (e.g., garbage, waste, recyclables, etc.) for hauling to a designated area, such as a landfill, transfer station, or material recovery facility. These vehicles hold the refuse in a relatively large storage container supported on the vehicle chassis. Many refuse collection vehicles include an onboard system—colloquially called a “packer”—that compacts the refuse within the storage container. Compacting the refuse increases the volume that the vehicle can hold in the storage container before the vehicle must travel to the designated area and eject the load.

### SUMMARY

Aspects of this disclosure are directed to vehicles, systems, and techniques that facilitate refuse collection, storage, and compaction.

In one aspect, a refuse collection vehicle includes: a vehicle chassis defining a forward and rearward direction of travel, and a refuse body on the vehicle chassis. The refuse body includes: a hopper; a storage container rearward of the hopper, a lift, and a packer. The storage container defines an enclosed volume for containing waste. The lift is configured to service a refuse container proximate the refuse collection vehicle by engaging the refuse container, lifting the refuse container, and depositing waste from the refuse container into the hopper. The packer is configured to transfer waste from the hopper into the storage container and to pack waste within the storage container. The refuse collection vehicle further includes a sensor and a controller. The sensor is configured to monitor a packer load. The controller is communicatively coupled to the sensor and is configured to assess, based on packer load data, a volumetric fullness of the storage container.

In another aspect combinable with the previous aspect, the controller is further configured to output an alert indicative of the volumetric fullness of the storage container.

In another aspect combinable with one or more of the previous aspects, the controller is further configured to adapt operations of at least one of the lift or the packer in response to determining that the storage container is full. In some implementations, the controller is configured to adapt operations by preventing movement of the at least one of the lift or the packer.

In another aspect combinable with one or more of the previous aspects, the packer includes an auger, and the packer load includes a torque associated with the auger. In some implementations, the sensor includes a torque measuring device. In some implementations, the auger includes an electric drive, and the sensor includes at least one of a current measuring device or a voltage measuring device.

In another aspect combinable with one or more of the previous aspects, the controller and the sensor are communicatively coupled by an onboard information network. In some implementations, the onboard information network includes a wired bus.

In another aspect combinable with one or more of the previous aspects, the controller is configured to assess the volumetric fullness by comparing the packer load data to a threshold value. In some examples, the threshold value includes a first value that corresponds to about 75% volumetric fullness of the storage container. In some examples, the threshold value includes a second value that corresponds to about 90% volumetric fullness of the storage container.

In another aspect combinable with one or more of the previous aspects, the controller is configured to assess the volumetric fullness by: defining a packing cycle, and evaluating a data set of packer load data corresponding to the defined packing cycle. In some implementations, the controller is further configured to identify an occurrence of a service event, and the defined packing cycle is based on the identified occurrence of the service event. According to some implementations, the sensor includes a first sensor, and the refuse collection vehicle further includes a second sensor. The second sensor is configured to monitor lift movement, and the controller is configured to identify the occurrence of a service event based on lift movement data. In some examples, the defined packing cycle includes a time window after the occurrence of the service event. In some examples, a start of the time window corresponds to a delay period after the occurrence of the service event. The delay period is about five seconds in some examples.

In another aspect combinable with one or more of the previous aspects, the defined packing cycle includes a time window. In some examples, the time window includes a window of time during which the packer is packing waste within the storage container. In some examples, a length of the time window corresponds to a predetermined time span. The predetermined time span is about five seconds in some examples.

In another aspect combinable with one or more of the previous aspects, the data set of packer load data includes data output from the sensor during the defined packing cycle.

In another aspect combinable with one or more of the previous aspects, the controller is configured to evaluate the data set of packer load data by identifying a maximum value in the data set. In some implementations, the controller is configured to assess the volumetric fullness by further aggregating the maximum value in the data set with other maximum values associated with other packing cycles. In some implementations, the controller is configured to assess the volumetric fullness by further tracking at least one of a rolling sum or a rolling average of maximum values across a predetermined number of packing cycles. According to some examples, the predetermined number of packing cycles is ten packing cycles.

In one aspect, a refuse collection vehicle includes: a vehicle chassis defining a forward and rearward direction of travel, and a refuse body on the vehicle chassis. The refuse body includes: a hopper; a storage container rearward of the hopper, a lift, and a packer. The storage container defines an enclosed volume for containing waste. The lift is configured to service a refuse container proximate the refuse collection vehicle by engaging the refuse container, lifting the refuse container, and depositing waste from the refuse container into the hopper. The packer is configured to transfer waste from the hopper into the storage container and to pack waste within the storage container. The refuse collection vehicle further includes a sensor and a controller. The sensor is configured to monitor a packer load. The controller is communicatively coupled to the sensor and is configured to determine, based on packer load data, that the packer is operating in an idle state.

In another aspect combinable with one or more of the previous aspects, the controller is further configured to, in response to determining that the packer is operating in an idle state, issue a control instruction to cease operation of the packer.

In another aspect combinable with one or more of the previous aspects, the packer includes an auger, and the packer load includes a torque associated with the auger. In some implementations, the sensor includes a torque measuring device. In some implementations, the auger includes an electric drive, and the sensor includes at least one of a current measuring device or a voltage measuring device.

In another aspect combinable with one or more of the previous aspects, the controller and the sensor are communicatively coupled by an onboard information network. In some implementations, the onboard information network includes a wired bus.

In another aspect combinable with one or more of the previous aspects, the controller is configured to determine that the packer is operating in an idle state by: identifying a duty interval, and evaluating a data set of packer load data corresponding to the identified duty interval. In some implementations, the controller is further configured to identify an occurrence of a service event, and the controller is configured to identify the duty interval based on the identified occurrence of the service event. According to some implementations, the sensor is a first sensor, and the refuse collection vehicle further includes a second sensor. The second sensor is configured to monitor lift movement, and the controller is configured to identify the occurrence of a service event based on lift movement data.

According to some implementations, the duty interval includes a time segment after the occurrence of the service event. According to some examples, a start of the time segment corresponds to a delay period after the occurrence of the service event. The delay period is about ten seconds in some examples.

In some implementations, the duty interval includes a time segment having a predetermined time span. The predetermined time span is about one second in some examples.

According to some implementations, the data set of packer load data includes data output from the sensor during the identified duty interval. In some implementations, the controller is configured to evaluate the data set of packer load data by identifying an averaged value corresponding to the data set. In some implementations, the controller is configured to determine that the packer is operating in an idle state by further: aggregating the averaged value in the data set with other averaged values associated with other packing cycles, and comparing the aggregate to a threshold value.

In some implementations, the controller is configured to determine that the packer is operating in an idle state by further: tracking at least one of a rolling sum or a rolling average of averaged values across a predetermined number of duty intervals, and comparing the at least one of the rolling sum or the rolling average to a threshold value. In some examples, the predetermined number of duty intervals is five duty intervals.

Particular implementations of the subject matter described in this specification can be implemented so as to realize one or more material advantages, such as improved operational efficiency and energy conservation.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 is a side view of a side-loading refuse collection vehicle featuring various aspects of the present disclosure.

FIG. 2 is a top view of the vehicle of FIG. 1 with a portion of the refuse collecting body hidden to show the internal volume of the storage container.

FIG. 3 is an enlarged portion of the top view of FIG. 2.

FIG. 4 is a first plot of a packer load data stream over the course of one or more refuse collecting routes.

FIG. 5 is a second plot of a packer load data stream following a service event.

FIG. 6 is a flowchart of a process that includes assessing, based on packer load data, a volumetric fullness of a storage container.

FIG. 7 is a display of a user interface system displaying a storage container fullness alert.

FIG. 8 is a flowchart of a process that includes determining, based on packer load data, that a packer is operating in an idle state.

FIG. 9 is a diagram depicting a control system for controlling one or more operational components of a refuse collection vehicle.

### DETAILED DESCRIPTION

Embodiments of the present disclosure feature techniques for determining a state of a refuse collecting system based on the load applied by or to a packer compacting the materials within a storage container. In some embodiments, for example, monitoring and analyzing packer load facilitates determining the volumetric fullness of the storage container and/or determining whether the packer is operating in an idle state (e.g., where the packer is operating but not performing compaction). The inventor(s) associated with this disclosure have discovered that fullness detection techniques accounting for packer load are more accurate than techniques that focus solely on the weight of the stored materials or the number of service events. Similarly, the inventor(s) have discovered that significant energy savings can be achieved by a control scheme that incorporates techniques for detecting and deactivating an idling packer.

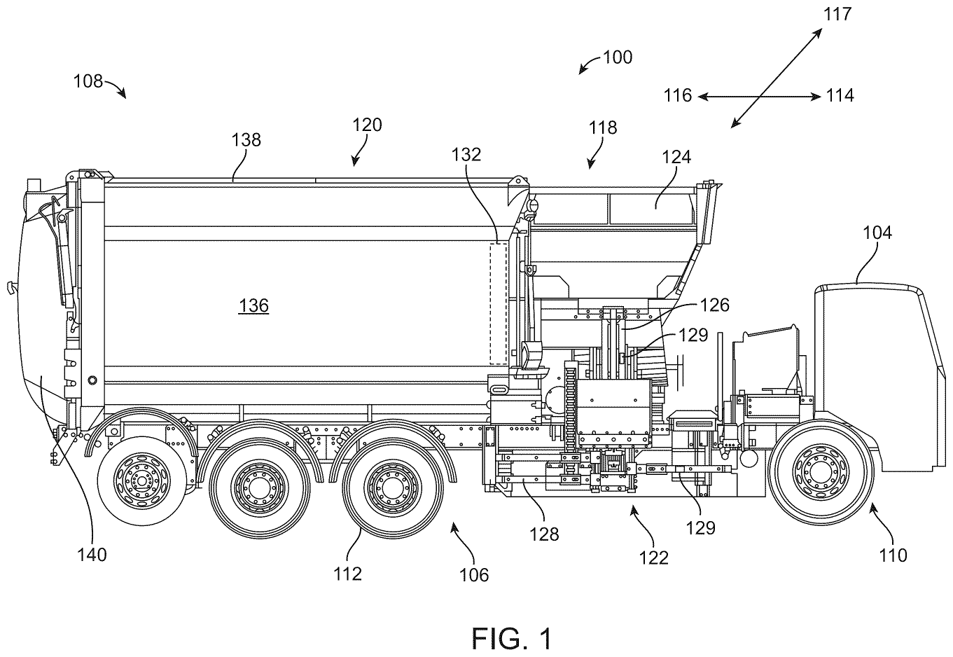

FIGS. 1-3 depict a vehicle 100 for collecting, packing, and transporting refuse (e.g., garbage) to a designated area, such as a landfill, transfer station, or material recovery facility. Refuse collection vehicles such as vehicle 100 are often described colloquially as garbage collection vehicles or just “garbage trucks.”

Refuse collection vehicle 100 includes a cab 104, a chassis 106, and a refuse collecting body 108. Cab 104 includes a compartment for a driver of vehicle 100. The compartment is equipped with controls that enable the driver to operate various elements of chassis 106 and body 108 and one or more displays that enable the driver to monitor such elements. Chassis 106 includes a power train 110 (e.g., a diesel, CNG, or electric power train). Power train 110, which includes a prime mover and a drivetrain, converts and transfers motive power to the wheels 112 that move vehicle 100 on a road surface along a forward direction of travel 114 and a rearward direction of travel 116. The direction across vehicle 100 and orthogonal to the forward/rearward directions is a transverse direction 117.

Refuse collecting body 108 includes an intake system 118, a storage container 120, a packer 130, an ejector 132, and a tailgate 140. Intake system 118 includes a lift 122 and a hopper 124. Lift 122 is operable to transfer the contents of residential refuse containers into storage container 120 via hopper 124. In this example, lift 122 includes a side-loading arm assembly including a reach (not shown), a mast 126, and a grabber 128. During use, when vehicle 100 pulls up to a residential refuse container, lift 122 performs a dump-cycle “service event” that includes: (i) moving the grabber 128 in the transverse direction away from the vehicle and toward the container via the reach; (ii) engaging (e.g., grasping) the container with the grabber 128; (iii) moving the grabber 128 with the container back toward the vehicle via the reach; (iv) raising the grabber 128 and the container vertically along the mast 126; and (v) dumping the contents of the container into the hopper 124. A set of one or more lift sensors 129 monitor operation of lift 122 during such a dump cycle.

Storage container 120 provides an enclosed refuse-containing volume defined (in part) by a floor 134, lateral side walls 136, and a cover 138. Ejector 132 features a movable panel that provides a front wall of the volume, separating storage container 120 from hopper 124. Tailgate 140 provides the volume's rear wall.

In this example, packer 130 features an auger 142 and an auger drive 144. Auger 142 resides within hopper 124 and includes a cylindrical tube carrying a helicoid flight on its outer surface. Auger drive 144 is an electric drive including a prime mover in the form of an electric motor. Auger drive 144 rotates the tube of auger 142 about its longitudinal axis, causing the flight to move like a screw thread. Movement of the flight conveys any waste in the hopper 124 rearward, where it passes through an aperture in the ejector 132 and enters the enclosed volume of the storage container 120. As waste builds up in the storage container 120, rotation of the auger 142 not only transfers new waste from the hopper 124 into the storage container 120 but also pushes the new waste against the existing waste already in the storage container 120. Compacting the waste in this manner decreases its volume and increases the storage capacity of the storage container. Additional details and descriptions regarding packing and ejecting can be found in United States Publication No. 2021/0039880, the entirety of which is incorporated herein by reference.

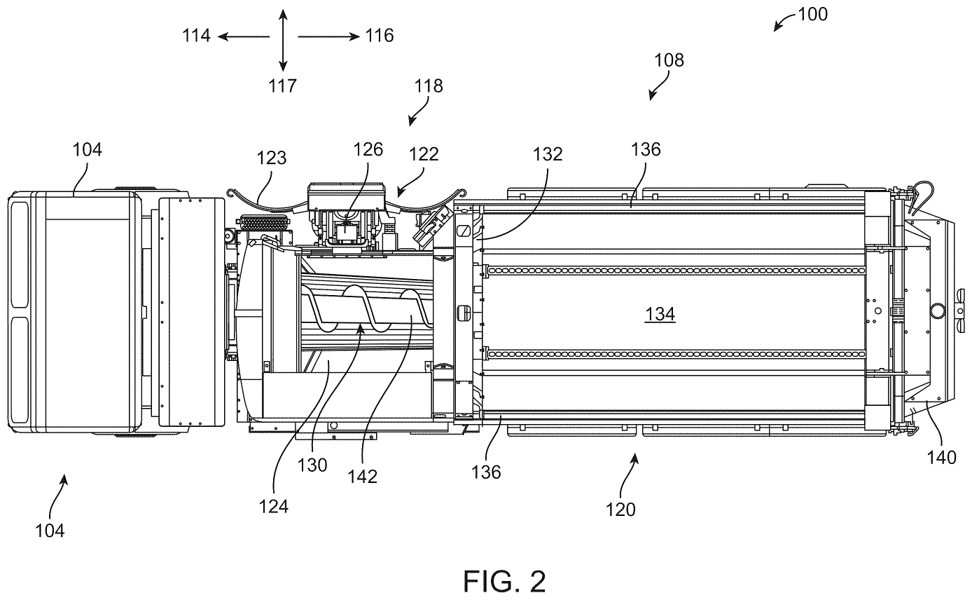

In one exemplary (but non-limiting) use-case, vehicle 100 traverses a refuse collection route including numerous (e.g., hundreds) of service stops to pick up residential refuse containers, dump waste into the hopper 124, transfer waste from the hopper 124 into the storage container 120, and compact the waste within the storage container 120. After completing all or a portion of a collection route, vehicle 100 travels to a designated area and ejects the waste from the storage container 120 using the ejector 132. To eject a load of waste, tailgate 140 pivots from a closed position (as shown in FIGS. 1-2) to an open position, and the panel of ejector 132 moves rearward, pushing the load through the tailgate opening (an “eject event”). A set of one or more ejector sensors 133 monitor operation of ejector 132 during such an ejection event.

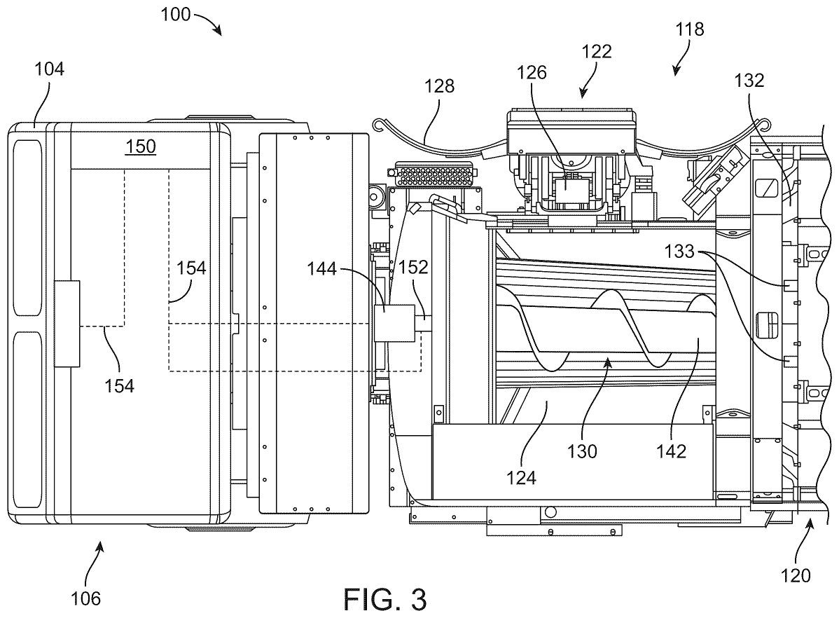

As shown in FIG. 3, vehicle 100 further includes a controller 150 that controls the operation of packer 130. Controller 150 is communicatively coupled with auger drive 144 and a packer load sensor 152 via an information network 154. Packer load sensor 152 monitors a load imparted on or by the packer 130 and outputs packer load data corresponding to the same. As one example, packer load sensor 152 may take the form of a torque measuring device (e.g., a rotary or reaction torque transducer, a load cell, etc.) that measures torque applied by a prime mover of auger drive 144 to another packer component (e.g., the tube of auger 142). As another example, packer load sensor 152 may take the form of a device that measures certain operating characteristics/qualities of the prime mover (e.g., a current or voltage measuring device). Packer load sensor 152 provides a stream of packer load data values. In this example, the data stream includes a plurality of packer load data values ranging between a lower limit (e.g., 0) and an upper limit (e.g., 1,000). Additionally, in this example, packer load sensor 152 outputs packer load data values according to a predetermined sample rate (e.g., 1 Hz, 10 Hz, or 100 Hz).

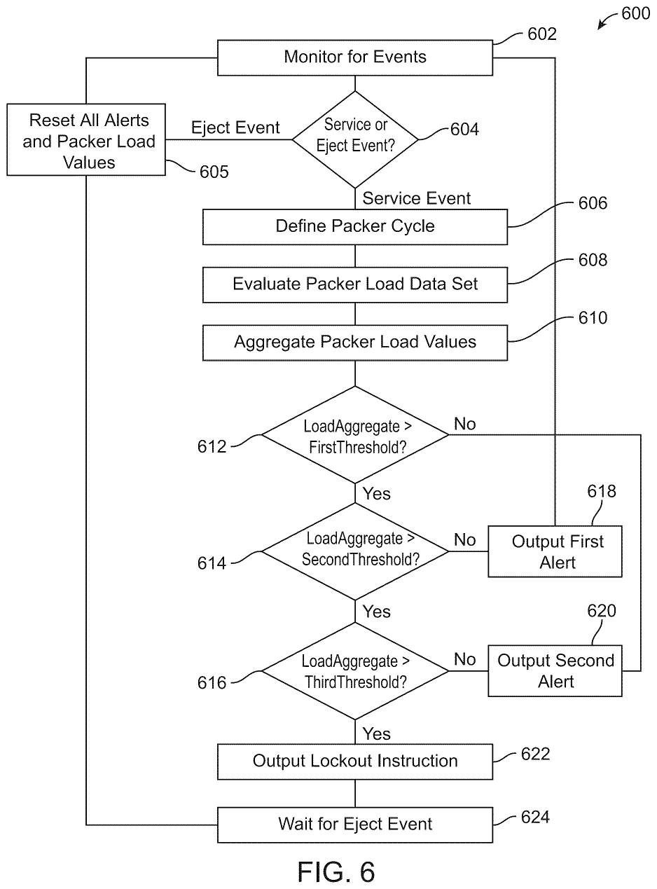

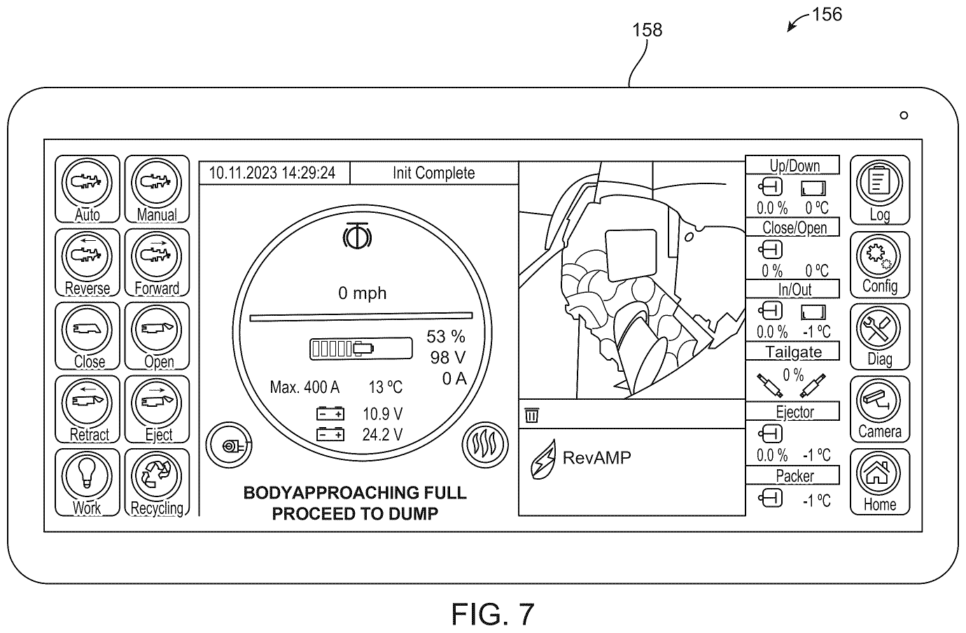

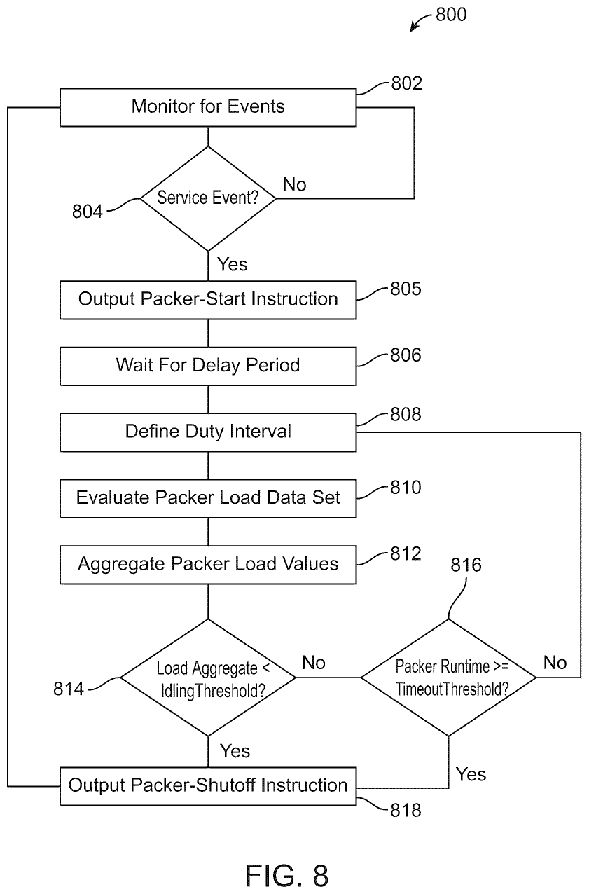

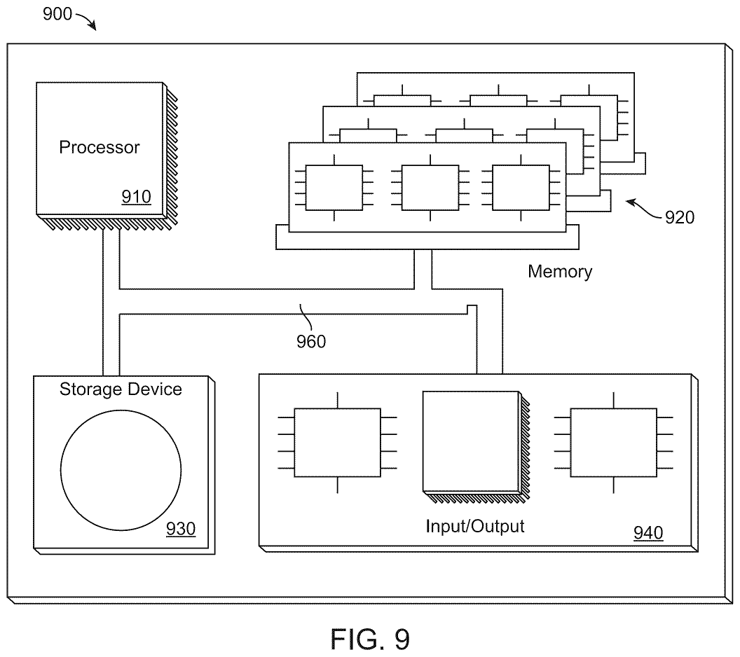

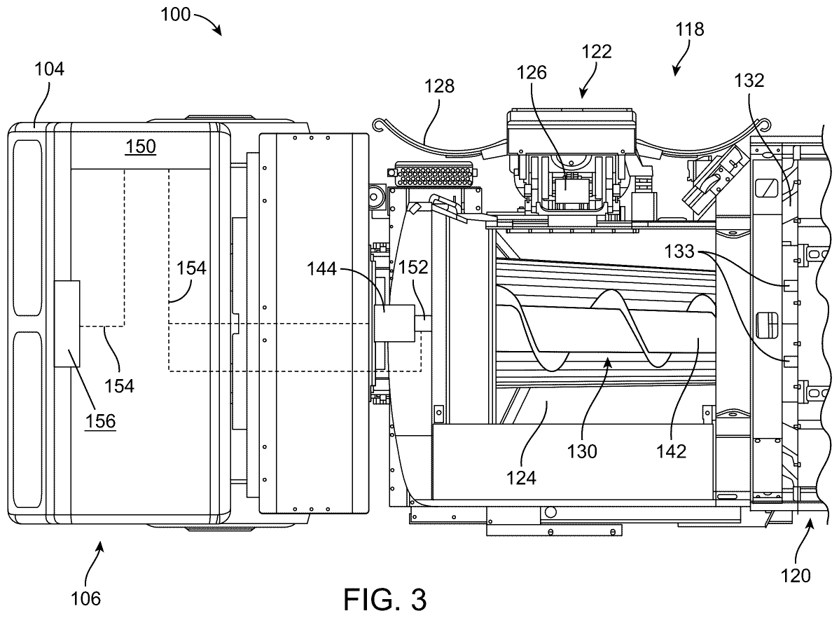

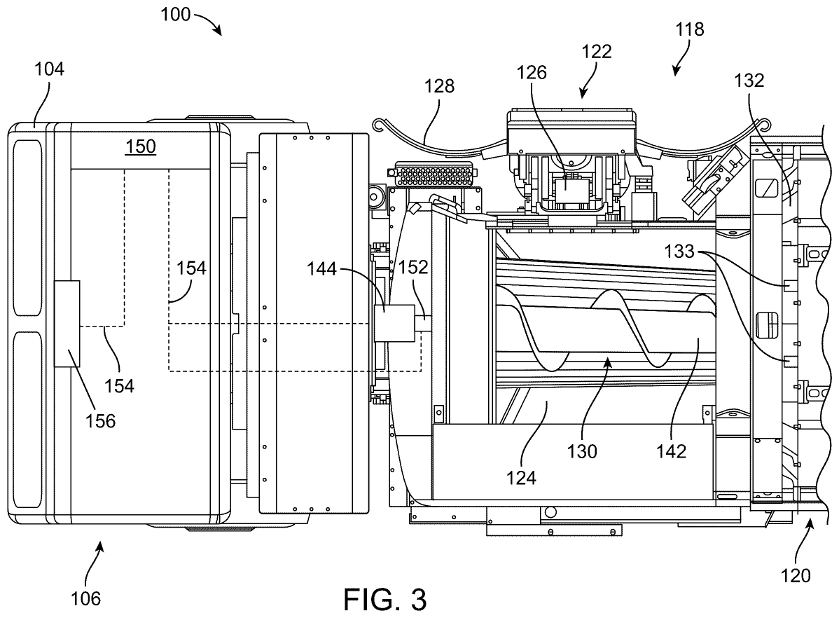

In this example, controller 150 is provided in the form of a programmable logic controller (PLC) with integral data input/output, memory, and processing components (see, e.g., FIG. 9), and information network 154 includes an onboard wired data bus. Controller 150 issues command signals through the information network 154 that cause auger drive 144 to rotate or cease rotating auger 142. Controller 150 performs control schemes and issues auger-control commands based on packer load data received, via information network 154, from packer load sensor 152. For example, controller 150 performs a container-fullness control scheme (see FIG. 6) and an auger control scheme (see FIG. 8). Controller 150 also provides, via information network 154, information (e.g., data, alerts, etc.) regarding the operation of refuse collecting body 108 to a user interface system 156 viewable by a human operator in the vehicle's cab 104 (see FIG. 7).

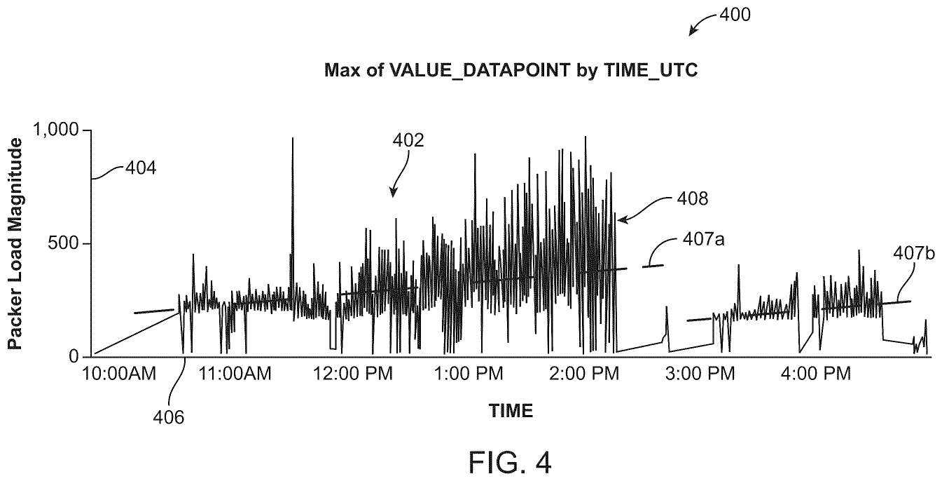

FIG. 4 is a plot 400 of a packer load data stream 402 during a refuse collection route traversed by vehicle 100. The vertical axis 404 represents the magnitude of the packer load data; and the horizontal axis 406 represents the passage of time. In this example, packer load data stream 402 includes a series of data points, each data point representing the maximum packer load data value received from packer load sensor 152 (see FIG. 3) during a packing cycle following a given dump-cycle service event.

Note that the magnitude of the packer load data stream 402 generally follows an increasing trendline 407a over time, as the vehicle 100 executes service events and collects waste in the storage container 120. The increasing trendline 407 indicates that, as the storage container 120 becomes increasingly full of waste, the packer 130 works harder to perform the compaction process. Accordingly, the trendline breaks (408) after an ejection event, which empties the storage container 130 and lessens the work of the packer 130. From there, as the vehicle conducts additional service events and collects more waste in storage container 120, a new increasing trendline 407b begins to form.

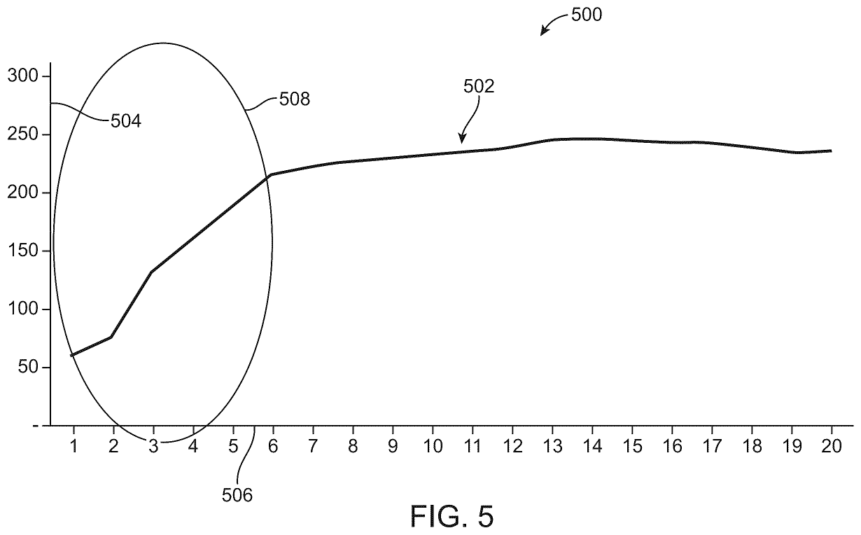

FIG. 5 is a plot 500 of a packer load data stream 502 associated with a packing cycle after a dump-cycle service event. The vertical axis 504 represents the magnitude of the packer load data; and the horizontal axis 506 represents the passage of time in seconds. In this example, packer load data stream 502 includes a series of data points, each data point representing a per-second average packer load data value. For example, if the sample rate of packer load sensor 152 is 10 Hz, the ten individual packer load data values produced each second by sensor 152 would be averaged, and the per-second average packer load data value would be included in data stream 502.

Note that the magnitude of the packer load data stream 502 increases during the initial “warm up” period 508 after a service event before reaching a substantially steady state. This warm-up period 508 indicates that it takes certain amount of time for the auger: (i) to come up to an operational level (e.g., speed) designated by the controller 150 and auger drive 144; and/or (ii) to start the work of packing waste deposited during the service event against the existing waste in the storage container. In some embodiments, the warm-up period 508 is between about 1-20 seconds, such as between about 2-15 seconds, between about 3-10 seconds, and/or about 5 seconds.

The term “about” in this disclosure, when used to describe any numerical range or value, references a margin within ±5% of the stated value or range.

The inventor(s) associated with this disclosure have discovered a number of ways to utilize packer load data streams to reliably and accurately detect different states of a refuse collecting body, including (but not necessarily limited to) a volumetric fullness of the storage container 120 (see FIG. 6) and whether the auger 142 is operating in an idle state (see FIG. 8). Volumetric fullness, in this context, provides an indication regarding how much of the storage container's refuse-containing volume is filled with waste or, alternatively, how much of the volume remains unfilled. The volume taken up by the waste is distinct from the weight of the waste. Although these characteristics may correlate in some instances, in others, they may diverge. For example, a refuse collecting vehicle may be reach the volumetric fullness limit of the storage container before reaching any weight limit(s), or vice versa.

FIG. 6 is a flowchart of a process 600 that includes assessing, based on packer load data, a volumetric fullness of a storage container (e.g., storage container 120) on a refuse collection vehicle (e.g., vehicle 100). In some embodiments, process 600 may be one of the control schemes performed by an onboard controller (e.g., controller 150). In some embodiments, process 600 may be performed by a remote computer based on data collected by sensors onboard the refuse collection vehicle. In some embodiments, the onboard controller performs one or more steps of process 600 and the remote computer performs one or more other steps of process 600.

Steps 602 and 604 includes monitoring for service and eject events. In this example a service event includes a dump cycle, where the refuse vehicle's lift (e.g., lift 122) performs a sequence of operations to deposit waste from a refuse container into the hopper (e.g., hopper 124); and an eject event includes operating the vehicle's ejector (e.g., ejector 132) to clear waste from the storage container. Additionally, in this example, monitoring for service and eject events includes receiving and processing sensor data corresponding to operation of the lift and ejector (e.g., data produced by lift sensor(s) 129 and ejector sensor(s) 133).

Following an eject event, the process 600 resets all alerts and stored packer load data values (step 605) and continues to monitor for future eject/service events (step 602). By contrast, following a service event, the process 600 includes defining a packing cycle (step 606). Defining a packing cycle includes establishing a time window after the occurrence of the service event and during which the packer (e.g., packer 130) is packing waste from the service event against existing waste in the storage container (assuming there is sufficient waste to pack). The time window extends between a start time and an end time. In this example, the start time corresponds to a first predetermined time period (e.g., a delay period or a warm-up period) after the service event and the end time corresponds to a second predetermined time period after the start time (or the service event). In some embodiments, the start time is between about 1-20 seconds after the service event, such as between about 2-15 seconds after the service event, between about 3-10 seconds after the service event, and/or about 5 seconds after the service event. In some embodiments, the end time is between about 1-20 seconds after the start time, such as between about 2-15 seconds after the start time, between about 3-10 seconds after the start time, and/or about 5 seconds after the start time. In a particular embodiment, the packing cycle corresponds to a time window that starts 5 seconds after the service event and ends 10 seconds after the service event, meaning the duration of the time window is 5 seconds.

Process 600 further includes evaluating a packer load data set (step 608). The packer load data set includes the data stream output by a packer load sensor (e.g., packer load sensor 152) during the time window of the packing cycle. In this example, evaluating the packer load data includes identifying a maximum packer load data value within the data stream of the packing cycle.

Process 600 further includes aggregating multiple packer load data values (step 610). In this example, the aggregation includes incorporating the maximum packer load data value for the current packing cycle into a rolling total of maximum packer load data values from multiple packing cycles. In some embodiments, the rolling total includes between about 2-20 maximum packer load data values, such as between about 5 -15 maximum packer load data values, between about 7-12 maximum packer load data values, and/or about 10 maximum packer load data values.

Process 600 further includes comparing the aggregate packer load value to a series of first, second, and third thresholds (steps 612, 614, 616). The first threshold corresponds to a first volumetric fullness level of the storage container (e.g., about 75% fullness). The second threshold corresponds to a second volumetric fullness level of the storage container (e.g., about 90% fullness) that is greater than the first. The third threshold corresponds to a third volumetric fullness of the storage container (e.g., about 100%) that is greater than the second. In a particular example, these thresholds are predetermined values derived empirically from a statistical analysis of historical packer load data streams collected during prior refuse collecting routes. The predetermined threshold values are then input and stored in the onboard controller and/or remote computer for executing the process 600.

In some embodiments, at least one of the first, second, and third thresholds can be defined as a multiple of the upper limit of the packer load data values. In some embodiments, the multiplying factor is between about 2-20, such as between about 3-15, and/or between about 4-12. In a particular implementation, the upper limit of the packer load data values is 1,000, the multiplying factor of the first threshold is about 5, and the multiplying factor of the second threshold is about 7. Thus, the first threshold is a value of about 5,000 and the second threshold is a value of about 7,000.

According to the comparison at step 612, if the aggregate packer load value is not greater than the first threshold, the process 600 returns to the event monitoring steps 602, 604. If, by contrast, the aggregate packer load value is greater than the first threshold, the process 600 proceeds to the second comparison at step 614. According to step 614, if the aggregate packer load value is not greater than the second threshold, the process 600 involves the additional step of outputting a first alert (step 618). For example, the onboard controller or remote computer may generate a command signal for the user interface system 156 to produce a visual and/or audible alert sufficient to notify the vehicle operator of the storage container's volumetric fullness. FIG. 7 depicts a non-limiting example of a visual alert displayed on a graphical display 158 of the user interface system 156. The alert, whether visual or audible, may include qualitative information (e.g., a general warning) and/or quantitative information (e.g., a numerical degree) regarding the volumetric fullness level of the storage container.

Going back to step 614, if the aggregate packer load value is greater than the second threshold, the process 600 proceeds to the third comparison at step 616. According to step 616, if the aggregate packer load value is not greater than the third threshold, the process 600 involves the additional step of outputting a second alert (step 620). If, by contrast, at step 616, the aggregate packer load value is greater than the third threshold—indicating that the storage container is completely full—the process 600 proceeds to adapt the operations of the refuse collecting vehicle by outputting a lockout instruction (622). In some embodiments, the lockout instruction includes an override command that prevents certain operative movements of the lift and/or packer. Once the lockout instruction has been issued, the process 600 waits for an ejection event (step 624) that resets all alerts and stored packer load data values (step 605) and continues to monitor for future eject/service events (step 602).

FIG. 8 is a flowchart of a process 800 that includes determining, based on packer load data, that a packer (e.g., packer 130) on a refuse collection vehicle (e.g., vehicle 100) is operating in an idle state. The packer may be operating in an idle state when the auger (e.g., auger 142) is being driven to rotate by a drive unit (e.g., auger drive 144) but is not performing useful packing work. Such an idle state may occur, for example, when the vehicle's storage container (e.g., storage container 120) does not contain enough existing waste for the new waste from the most recent service event to be compacted against.

In some embodiments, process 800 may be one of the control schemes performed by an onboard controller (e.g., controller 150). In some embodiments, process 800 may be performed by a remote computer based on data collected by sensors onboard the refuse collection vehicle. In some embodiments, the onboard controller performs one or more steps of process 800 and the remote computer performs one or more other steps of process 800.

Steps 802 and 804 includes monitoring for service events. In this example, as discussed, a service event includes a dump cycle, where the refuse vehicle's lift (e.g., lift 122) performs a sequence of operations to deposit waste from a refuse container into the hopper (e.g., hopper 124). Additionally, in this example, monitoring for service events includes receiving and processing sensor data corresponding to operation of the lift (e.g., data produced by lift sensor(s) 129).

Following a service event, the process 800 includes outputting an instruction to begin operation of the packer (step 805) and waiting for a delay period (step 806) while the packer is operating. In some embodiments, the delay period corresponds to the warm-up period of the auger. In some embodiments, the delay period is between about 1-30 seconds after the service event, such as between about 5-20 seconds after the service event, between about 7-15 seconds after the service event, and/or about 10 seconds after the service event.

Following the delay period, the process includes defining a duty interval (step 808). In this example, the duty interval comprises a time segment of a predetermined duration. In some embodiments the duration is between about 0.1-5 seconds, such as between about 0.2-3 seconds, between about 0.5-2 seconds, and/or about 1 second. Initially, the duty interval (DI₀) is the time segment immediately after the delay period. For future iterations (n), the duty interval (DIₙ) is the time segment immediately after the prior time segment of the prior duty interval (DIₙ₋₁).

Process 800 further includes evaluating a packer load data set (step 810). The packer load data set includes the data stream output by a packer load sensor (e.g., packer load sensor 152) during the time segment of the duty interval. In this example, evaluating the packer load data includes averaging the individual packer load data values within the data stream of the duty interval.

Process 800 further includes aggregating multiple averaged packer load data values (step 812). In this example, the aggregation includes incorporating the averaged packer load data value for the current duty interval into a rolling total of averaged packer load data values from multiple duty intervals. In some embodiments, the rolling total includes between about 2-20 average packer load data values, such as between about 2-15 average packer load data values, between about 3-12 average packer load data values, and/or about 5 average packer load data values, and/or about 4 average packer load data values, and/or about 3 average packer load data values.

Process 800 further includes comparing the aggregate packer load value to an idling threshold value (step 814). In a particular example, this idling threshold value is derived empirically from a statistical analysis of historical packer load data streams collected during prior refuse collecting routes. The idling threshold value is then input and stored in the onboard controller and/or remote computer for executing the process 800.

In some embodiments, the idling threshold can be defined as a multiple of the upper limit of the packer load data values. In some embodiments, the multiplying factor is between about 0.01-1.00, such as between about 0.05-0.80, between about 0.10-0.50, about 0.20, about 0.16, about 0.12, about 0.10, and/or about 0.08. In a particular implementation, the upper limit of the packer load data values is 1,000 and the multiplying factor of the threshold is about 0.12. Thus, the idling threshold is about 120.

According to comparison step 814, if the aggregate packer load value is not less than the idling threshold value, the process 800 determines, at step 816, whether the packer runtime—that is, the amount of time the packer has been operating after the service event—is greater than or equal to a predetermined timeout threshold (e.g., about 25-30 seconds). If the packer runtime is not greater than or equal to the timeout threshold, the process 800 returns to execute a subsequent iteration of steps 808-814. If the packer runtime is greater than or equal to the timeout threshold, the process 800 outputs an instruction to shut off the packer (step 818). Additionally, per step 814, if the packer load value is less than the idling threshold value, the process outputs the packer-shutoff instruction (step 818).

The controllers, control units and/or computing devices described throughout this disclosure can include or employ one or more computing systems. FIG. 9 depicts an example computing system 900. The system 900 may be used for any of the operations or functions described in this disclosure with reference to a computing device. For example, the system 900 may be included, at least in part, in controller 150 and/or any other computing device(s) or system(s) associated with the refuse collecting vehicle 100. The system 900 includes one or more processors 910, a memory 920, one or more storage devices 930, and one or more input/output (I/O) devices controllable via one or more I/O interfaces 940. The various components 910, 920, 930, or 940 may be interconnected via at least one system bus 960, which may enable the transfer of data between the various modules and components of the system 900.

The system bus 960 may include a series of wired or wireless connections. In some embodiments, the system bus includes a CAN network bus operating under the J1939 protocol.

The processor(s) 910 may be configured to process instructions for execution within the system 900. The processor(s) 910 may include single-threaded processor(s), multi-threaded processor(s), or both. The processor(s) 910 may be configured to process instructions stored in the memory 920 or on the storage device(s) 930. For example, the processor(s) 910 may execute instructions for the various software module(s) described herein. The processor(s) 910 may include hardware-based processor(s) each including one or more cores. The processor(s) 910 may include general purpose processor(s), special purpose processor(s), or both.

The memory 920 may store information within the system 900. In some embodiments, the memory 920 includes one or more computer-readable media. The memory 920 may include any number of volatile memory units, any number of non-volatile memory units, or both volatile and non-volatile memory units. The memory 920 may include read-only memory, random access memory, or both. In some examples, the memory 920 may be employed as active or physical memory by one or more executing software modules.

The storage device(s) 930 may be configured to provide (e.g., persistent) mass storage for the system 900. In some embodiments, the storage device(s) 930 may include one or more computer-readable media. For example, the storage device(s) 930 may include a floppy disk device, a hard disk device, an optical disk device, or a tape device. The storage device(s) 930 may include read-only memory, random access memory, or both. The storage device(s) 930 may include one or more of an internal hard drive, an external hard drive, or a removable drive.

One or both of the memory 920 or the storage device(s) 930 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 900. In some embodiments, the CRSM may include a data store that provides storage of computer-readable instructions or other information in a non-transitory format. The CRSM may be incorporated into the system 900 or may be external with respect to the system 900. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, DRAM, and flash memory devices; magnetic disks such as internal hard disks and removable disks; magneto-optical disks; and CD-ROM and DVD-ROM disks. In some examples, the processor(s) 910 and the memory 920 may be supplemented by, or incorporated into, one or more application-specific integrated circuits (ASICs).

The system 900 may include one or more I/O devices (not shown). The I/O device(s) may include one or more input devices such as a joystick, keypad, keyboard, a mouse, a pen, a game controller, a touch input device (e.g., a touch pad), an audio input device (e.g., a microphone), a gestural input device, a haptic input device, an image or video capture device (e.g., a camera), a mobile device, or other devices. In some examples, the I/O device(s) may also include one or more output devices such as a display, LED(s), an audio output device (e.g., a speaker), a printer, a haptic output device, and so forth. The I/O device(s) may be physically incorporated in one or more computing devices of the system 900, or may be external with respect to one or more computing devices of the system 900.

The system 900 may include one or more I/O interfaces 940 to enable components or modules of the system 900 to control, interface with, or otherwise communicate with the I/O device(s). The I/O interface(s) 940 may enable information to be transferred in or out of the system 900, or between components of the system 900, through serial communication, parallel communication, or other types of communication. For example, the I/O interface(s) 940 may comply with a version of the RS-232 standard for serial ports, or with a version of the IEEE 1284 standard for parallel ports. As another example, the I/O interface(s) 940 may be configured to provide a connection over Universal Serial Bus (USB) or Ethernet. In some examples, the I/O interface(s) 940 may be configured to provide a serial connection that is compliant with a version of the IEEE 1394 standard.

The I/O interface(s) 940 may also include one or more network interfaces that enable communications between computing devices in the system 900, or between the system 900 and other network-connected computing systems. The network interface(s) may include one or more network interface controllers (NICs) or other types of transceiver devices configured to send and receive communications over one or more communication networks using any network protocol.

Computing devices of the system 900 may communicate with one another, or with other computing devices, using one or more communication networks. Such communication networks may include public networks such as the internet, private networks such as an institutional or personal intranet, or any combination of private and public networks. The communication networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some embodiments, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 900 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), embodiments are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

A number of embodiments have been described. Nevertheless, it will be understood that various modifications may be made without departing from the spirit and scope of the disclosure. Accordingly, other embodiments are within the scope of the following claim(s).

For example, although the vehicle described above is a refuse collection vehicle referred to as “garbage truck” that collects refuse or garbage, in some embodiments, such a vehicle is designed to collect a variety of different types of used or discarded materials—e.g., recyclables, hazardous materials, construction materials, etc.

As another example, although the cab of the refuse vehicle is described above as featuring a compartment for a human driver, in some embodiments, the refuse vehicle can be operated autonomously or semi-autonomously, or a combination thereof.

As yet another example, some embodiments of this disclosure can be implemented without a mobile vehicle chassis. For instance, the storage container and packer can be fixed in place on a ground surface.

As yet another example, although the refuse vehicle is described above as having side-loading lift, in some embodiments, the refuse vehicle may have a front-loading lift, and/or a rear-loading lift, or no lift at all.

As yet another example, although the service event described above includes certain specific operations of an automated dump cycle, the concept of a “service event” is more broadly understood and used in this disclosure. For example, in some embodiments, a service event may include a dump cycle including different operations or the same operations performed in a different order (or simultaneously). Additionally, in some embodiments, a service event may include some other manner of depositing waste (or other materials) onto the vehicle. For instance, a service event may include a human worker (or customer) placing the waste into a receptacle of the vehicle.

As yet another example, although the packer described above features an auger-style compactor, in some embodiments, the packer may include a translating packer blade.

As yet another example, although the auger drive described above is an electric drive featuring an electric motor, in some embodiments, the auger drive can take a variety of different forms. For instance, the auger drive may include a hydraulic, pneumatic, or a combustion-based prime mover. Moreover, in some examples, the auger drive may further include various transmission elements (e.g., gearing) to transmit power from the prime mover to the auger (or packer blade).

As yet another example, an addition to the above-described sensors for monitoring the lift, packer, and ejector, the refuse vehicle may further include sensors for monitoring a variety of other components, operations, and/or the vehicle's surrounding environment. Such sensors may take a variety of forms. For example, the sensors can include, but are not limited to, an analog sensor, a digital sensor, a CAN bus sensor, a magnetostrictive sensor, a radio detection and ranging (RADAR) sensor, a light detection and ranging (LIDAR) sensor, a laser sensor, an ultrasonic sensor, an infrared (IR) sensor, a stereo camera, a three-dimensional (3D) camera, or a combination thereof.

As yet another example, the communicative coupling between the above-described logical controller (e.g., controller 150) and the auger/packer drive may take a variety of forms. For instance, in some embodiments, the logical controller provides command instructions to the drive, and those instructions trigger the drive to regulate operation of the auger (packer). Alternatively, in some embodiments, the logical controller provides command instructions to an energy source or intermediate controller—e.g., a battery pack, a converter (battery controller), or a hydraulic pump or valve)—that powers and regulates the drive.

As yet another example, in some embodiments, the packer load data may include the integrated, aggregated, or otherwise combined output of multiple different sensors monitoring various aspects of the packer. As yet another example, in some embodiments, the packer load data output by the one or more sensors may include raw measured data and/or data pre-processed by the senor(s). As yet another example, in some embodiments, data output from the one or more sensor(s) may be triggered by the occurrence of an event (e.g., activation of the auger/packer), occur at predetermined time intervals, and/or occur in response to a received request (e.g., from the logical controller).

As yet another example, although the logical controller (e.g., controller 150) is described and illustrated above as operating the auger/packer, in some embodiments the logical controller may be integrated with one or more other onboard computing devices that control different assemblies or systems of the vehicle chassis or refuse collecting body (e.g., the ejector, lift, tailgate, etc.). As yet another example, although the logical controller is described and illustrated above as an onboard component, in some embodiments, the controller may be implemented such that one or more of its processing or storage components resides at a remote location.

As yet another example, although the information network is described above as an onboard wired data bus, in some embodiments, the network may take the form of a wireless network.

As yet another example, although the logical controller (e.g., controller 150) is described above as issuing control instructions/commands based on packer load data, in some embodiments, the controller may be operable to issue such instructions/commands in response to user input and/or requests from a remote computing device.

As yet another example, the above-described process for assessing, based on packer load data, a volumetric fullness of a refuse vehicle storage container may further include one or more steps to account for the total number of service events performed during a particular refuse collection route. For instance, the process steps that involve identifying a packing cycle, evaluating packer load data, etc., may not occur until after the vehicle has performed a threshold number of service events (e.g., between about 100-900 service events, between 200-700, between 250-500 service events, and/or about 300 service events).

As yet another example, the above-described process for assessing, based on packer load data, a volumetric fullness of a refuse vehicle storage container may further include one or more steps to account for the total weight of materials in the storage container during a particular refuse collection route. For instance, the process steps that involve identifying a packing cycle, evaluating packer load data, etc., may not occur until after the weight of the stored materials reaches a certain threshold.

As yet another example, although the above-discussed embodiments include monitoring for service and eject events by receiving and processing sensor data, in some embodiments, such monitoring may account for user input by an operator and/or requests from a remote computing device.

As yet another example, as an alternative to the above-described techniques for defining a packing cycle, in some embodiments, a packing cycle corresponds to the operating duration of the auger/packer. For example, such a packing cycle may extend from the first non-zero load data point to the next zero load data point.

As yet another example, although the above-discussed embodiments describe evaluating a packer load data set corresponding to a given packer cycle in terms of identifying a maximum data value, in some embodiments, the evaluation process includes identifying the minimum value, identifying a certain percentile value (e.g., 5^{th} percentile, the 10^{th} percentile, the 90^{th} percentile, the 95% percentile), or taking a mean/median/mode within the data set.

As yet another example, although the above-discussed embodiments describe aggregating packer load data values from multiple packer cycles in terms of calculating a rolling sum, in some embodiments, the aggregating process includes calculating a rolling mean/median/mode and/or performing other known data processing techniques. For instance, the aggregating process may include clustering operations—e.g., identifying a certain number of consecutive values above or below a given threshold.

As yet another example, although the above-discussed embodiments describe comparing aggregate packer load data values from multiple packer cycles to empirically-derived static thresholds, in some embodiments, the thresholds are dynamically derived or adjusted over time (e.g., during a refuse collection route or between routes). Additionally, in some embodiments, the thresholds are determined using heuristic and/or machine learning, and/or artificial intelligence techniques.

As yet another example, although the above-discussed embodiments describe outputting an alert via an onboard user interface system, in some embodiments, such an alert can be conveyed to a remote computing device.

As yet another example, although the above-discussed embodiments describe outputting a lockout instruction that prevents certain operative movements of the lift and/or packer, some embodiments may involve additional or alternative actions in response to surpassing a given volumetric fullness threshold. For instance, surpassing such a threshold may prompt a change in the route information displayed to the operator via the user interface system. The route information may change to direct the operator to the nearest designated area for depositing collected refuse. Additionally or alternatively, surpassing a volumetric fullness threshold may prompt the vehicle to move in an (at least partially) automated fashion toward such a designated area.

As yet another example, although the above-discussed embodiments describe evaluating a packer load data set corresponding to a given duty interval in terms of calculating an average data value, in some embodiments, the evaluation process includes identifying a maximum value, identifying a minimum value, identifying a certain percentile value (e.g., 5^{th} percentile, the 10^{th} percentile, the 90^{th} percentile, the 95% percentile), or taking a mean/median/mode within the data set.

As yet another example, although the above-discussed embodiments describe aggregating packer load data values from multiple duty intervals in terms of calculating a rolling sum, in some embodiments, the aggregating process includes calculating a rolling mean/median/mode and/or performing other known data processing techniques. For instance, the aggregating process may include clustering operations—e.g., identifying a certain number of consecutive values above or below a given threshold.

As yet another example, although the above-discussed embodiments describe comparing aggregate packer load data values from multiple duty intervals to empirically-derived static thresholds, in some embodiments, the thresholds are dynamically derived or adjusted over time (e.g., during a refuse collection route or between routes). Additionally, in some embodiments, the thresholds are determined using heuristic and/or machine learning, and/or artificial intelligence techniques.

In some implementations, the above-described refuse collection vehicle is an all-electric vehicle or an at least partially electric vehicle. For example, one or more (e.g., all) motive power elements, body controls, and sub-systems of the refuse collection vehicle can be electrically powered by onboard battery packs.

1. A refuse collection vehicle, comprising:
a vehicle chassis defining a forward and rearward direction of travel;
a refuse body on the vehicle chassis, the refuse body comprising:
a hopper;
a storage container rearward of the hopper, the storage container defining an enclosed volume for containing waste;
a lift configured to service a refuse container proximate the refuse collection vehicle by engaging the refuse container, lifting the refuse container, and depositing waste from the refuse container into the hopper; and
a packer configured to transfer waste from the hopper into the storage container and to pack waste within the storage container;
a sensor configured to monitor a packer load; and
a controller communicatively coupled to the sensor, the controller configured to assess, based on packer load data generated by the sensor, a volumetric fullness of the storage container.

2. The refuse collection vehicle of claim 1, wherein the controller is further configured to output an alert indicative of the volumetric fullness of the storage container.

3. The refuse collection vehicle of claim 1, wherein the controller is further configured to adapt operations of at least one of the lift or the packer in response to determining that the storage container is full.

4. The refuse collection vehicle of claim 3, wherein the controller is configured to adapt operations by preventing movement of the at least one of the lift or the packer.

5. The refuse collection vehicle of claim 1, wherein:
the packer comprises an auger;
the packer load comprises a torque associated with the auger; and
the sensor comprises at least one of:
a torque measuring device;
a current measuring device; or
a voltage measuring device.

6. The refuse collection vehicle of claim 1, wherein the controller is configured to assess the volumetric fullness by comparing the packer load data to a threshold value.

7. The refuse collection vehicle of claim 1, wherein the controller is configured to assess the volumetric fullness by:
defining a packing cycle; and
evaluating a data set of packer load data corresponding to the defined packing cycle.

8. The refuse collection vehicle of claim 7, wherein the controller is further configured to identify an occurrence of a service event, and wherein the defined packing cycle is based on the identified occurrence of the service event.

9. The refuse collection vehicle of claim 8, wherein the sensor comprises a first sensor, wherein the refuse collection vehicle further comprises a second sensor configured to monitor lift movement, and wherein the controller is configured to identify the occurrence of a service event based on lift movement data.

10. The refuse collection vehicle of claim 8, wherein the defined packing cycle comprises a time window after the occurrence of the service event.

11. The refuse collection vehicle of claim 7, wherein the defined packing cycle comprises a time window during which the packer is packing waste within the storage container.

12. The refuse collection vehicle of claim 11, wherein a length of the time window corresponds to a predetermined time span.

13. The refuse collection vehicle of claim 7, wherein the data set of packer load data comprises data output from the sensor during the defined packing cycle.

14. The refuse collection vehicle of claim 7, wherein the controller is configured to:
evaluate the data set of packer load data by identifying a maximum value in the data set; and
assess the volumetric fullness by performing at least one of:
further aggregating the maximum value in the data set with other maximum values associated with other packing cycles; or
further tracking at least one of a rolling sum or a rolling average of maximum values across a predetermined number of packing cycles.

15. A refuse collection vehicle, comprising:
a vehicle chassis defining a forward and rearward direction of travel;
a refuse body on the vehicle chassis, the refuse body comprising:
a hopper;
a storage container rearward of the hopper, the storage container defining an enclosed volume for containing waste;
a lift configured to service a refuse container proximate the refuse collection vehicle by engaging the refuse container, lifting the refuse container, and depositing waste from the refuse container into the hopper; and
a packer configured to transfer waste from the hopper into the storage container and to pack waste within the storage container;
a sensor configured to monitor a packer load; and
a controller communicatively coupled to the sensor, the controller configured to determine, based on packer load data generated by the sensor, that the packer is operating in an idle state.

16. The refuse collection vehicle of claim 15, wherein the controller is further configured to, in response to determining that the packer is operating in an idle state, issue a control instruction to cease operation of the packer.

17. The refuse collection vehicle of claim 15, wherein the packer comprises an auger, and wherein the packer load comprises a torque associated with the auger.

18. The refuse collection vehicle of claim 15, wherein the controller is configured to determine that the packer is operating in an idle state by:
identifying a duty interval and
evaluating a data set of packer load data corresponding to the identified duty interval.

19. The refuse collection vehicle of claim 18, wherein the controller is configured to:
evaluate the data set of packer load data by identifying an averaged value corresponding to the data set.

20. The refuse collection vehicle of claim 19, wherein the controller is configured to determine that the packer is operating in an idle state by further:
tracking at least one of a rolling sum or a rolling average of averaged values across a predetermined number of duty intervals; and
comparing the at least one of the rolling sum or the rolling average to a threshold value.
